(19) United States
(12) Patent Application Publication
(10) Pub. No.: US 2006/0249441 A1
(43) Pub. Date: Nov. 9, 2006

(54) Nanofluidic connector for hollow microfiber and method for manufacture thereof

(76) Inventors: Jeffery W. Baur, Liberty Township, OH (US); Corey P. Fucetola, Boston, MA (US); Nicolas Szita, Hoersholm (DK)

Correspondence Address: PEARL COHEN ZEDEK, LLP, 1500 BROADWAY 12TH FLOOR, NEW YORK, NY, 10036, US

(21) Appl. No.: 11/412,991

(22) Filed: Apr. 28, 2006

Related U.S. Application Data
(60) Provisional application No. 60/677,406, filed on May 4, 2005.

(51) Int. Cl. B01D 63/04

(52) U.S. Cl. 210/321.88; 210/455; 210/323.2

(57) ABSTRACT

An apparatus to hold hollow fibers for transporting fluid may include a channel such as a connecting channel, for example formed in a substrate, including extensions or ridges to hold a hollow fiber. The pullout force for the hollow fiber may exceed the mechanical strength of the hollow fiber. A method for making such a device, or for making a nanofluidic connector, may include forming or drilling holes on a substrate along a line, where the holes are generally perpendicular to the substrate and have a desired depth.

### PRIOR APPLICATION DATA

The present application claims benefit and priority from prior U.S. provisional application Ser. No. 60/677,406, filed on May 4, 2005 and entitled “NANOFLUIDIC CONNECTOR FOR HOLLOW MICROFIBER AND METHOD FOR MANUFACTURE THEREOF”, incorporated by reference herein in its entirety.

### FIELD OF THE INVENTION

This invention generally relates to an apparatus for holding and/or connecting hollow microfibers to, for example, assist fluid transportation therein and a method for manufacture thereof. In particular, it relates to a nanofluidic connector or interface for hollow microfibers.

### BACKGROUND OF THE INVENTION

A hollow microfiber based fluidic system may have the potential applications of a traditional microfluidic and/or nanofluidic system such as, for example, applications for chemical analysis, biological sensing, drug delivery, and enviromnental monitoring. In addition, because of the flexibility of hollow microfibers, or hollow fibers as they may be referred to herein, the system may be made part of, for example, a complex, multi-functional textile fabric. For example, hollow fibers may be woven or incorporated into a fabric that may, as a result, perform functions such as communication, actuation, and thermal management, in addition to those listed above. Mechanical properties of the fabric may also change actively in response to, for example, environmental changes such as temperature. A hollow fiber based, body-worn nanofluidic system may also function as an artificial or auxiliary circulatory system, for which some medical applications may be possible.

Hollow fibers may be manufactured, for example, in bulk out of a variety of melt spinnable polymers, and may have complex cross-sections and different materials within the same cross-section. The cross-section of a hollow fiber may include single or multiple cavities with feature sizes, for example, in the tens of nanometers range. Inside these nano-sized cavities, fluid flow may be required. For example, some applications may require an interlaced, hollow fiber based, transport system having flows of different fluid types therein, with monitoring and controlling functions for each fluid type. It is therefore envisioned that non-traditional, nano-enabled fluid transport mechanisms such as switchable surfaces and thin conducting polymer actuators may be needed to efficiently transport fluids at these nano-scaled cavities. There is a need for an effective connecting mechanism for such fibers.

### SUMMARY OF THE INVENTION

Nanofluidic connectors or interfaces may be one of the key enablers for a nanofluidic system. They may be able to hold firmly one or more hollow fibers to allow fluids being injected into and/or taken out of the hollow fibers for the various purposes listed above. In addition, a flexible nanofluidic textile fabric may include multiple hollow fibers. Therefore, nanofluidic connectors or interfaces may be able to interconnect pieces of hollow fibers together to enable transportation and/or circulation of fluid among them. Furthermore, nanofluidic connectors or interfaces may be essential elements in a test-bed setup used to test and demonstrate various nano-enabled fluid transport concepts.

Embodiments of the invention may provide a nanofluidic connector or interface apparatus adapted to hold one or more hollow fibers for transportation of fluid, such as, for example, liquids, gases, or a combination thereof. The apparatus may include, for example, a substrate machined with one or more connecting channels, wherein each channel may contain a set of protrusions or ridges formed on the sidewalls of the connecting channel. The connecting channel may hold a hollow fiber to allow fluid being injected into and/or taken out of the hollow fiber. Fluid may also be transported from one hollow fiber to another or distributed among multiple hollow fibers via the connector or interface apparatus by the use of one or more guiding channels. The guiding channels may be machined on the same substrate of the apparatus as the connecting channels.

Embodiments of the invention may also provide a nanofluidic system. The system may contain multiple nanofluidic connector or interface apparatuses and at least one set of hollow fibers interconnecting the connector or interface apparatuses. Transportation and circulation of fluid among the connector or interface apparatuses may be enabled by the set of hollow fibers.

A method for manufacturing the connector or interface apparatus and device is also disclosed.

An apparatus to hold hollow fibers for transporting fluid may include a channel such as a connecting channel, for example formed in a substrate, including extensions or ridges to hold a hollow fiber. The pullout force for the hollow fiber may exceed the mechanical strength of the hollow fiber. A method for making such a device, or for making a nanofluidic connector, may include forming or drilling holes on a substrate along a line, where the holes are generally perpendicular to the substrate and have a desired depth.

### BRIEF DESCRIPTION OF THE DRAWINGS

The invention will be understood and appreciated more fully from the following detailed description of embodiments of the invention, taken in conjunction with the accompanying drawings of which:

FIG. 1 is a simplified schematic illustration of a nanofluidic system having two connector or interface apparatuses connected by a set of flexible hollow fibers according to exemplary embodiments of the invention;

FIGS. 2A and 2B are schematic illustrations of top and cross-sectional views of a nanofluidic connector or interface adapted to hold a hollow fiber for fluid transportation according to exemplary embodiments of the invention;

FIGS. 3A, 3B, and 3C are schematic illustrations of some shapes of protrusions or ridges which may be formed on the sidewalls of a connecting channel to hold hollow fibers according to exemplary embodiments of the invention;

FIG. 4 is a simplified perspective illustration of a nanofluidic connector or interface adapted to hold a hollow fiber for fluid transportation according to exemplary embodiments of the invention; and

FIGS. 5A, 5B, and 5C are schematic illustrations of sample nanofluidic connector or interface apparatuses adapted to hold and/or connect one or more hollow fibers according to exemplary embodiments of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of embodiments of the invention. However it will be understood by those of ordinary skill in the art that embodiments of the invention may be practiced without these specific details. In other instances, well-known methods and procedures have not been described in detail so as not to obscure the embodiments of the invention.

In the following description, various figures, diagrams, models, and descriptions are presented as different paths to effectively convey the substance and illustrate different embodiments of the invention that are proposed in this application. It shall be understood by those skilled in the art that they are provided merely as exemplary samples, and shall not be constructed as limitation to the invention.

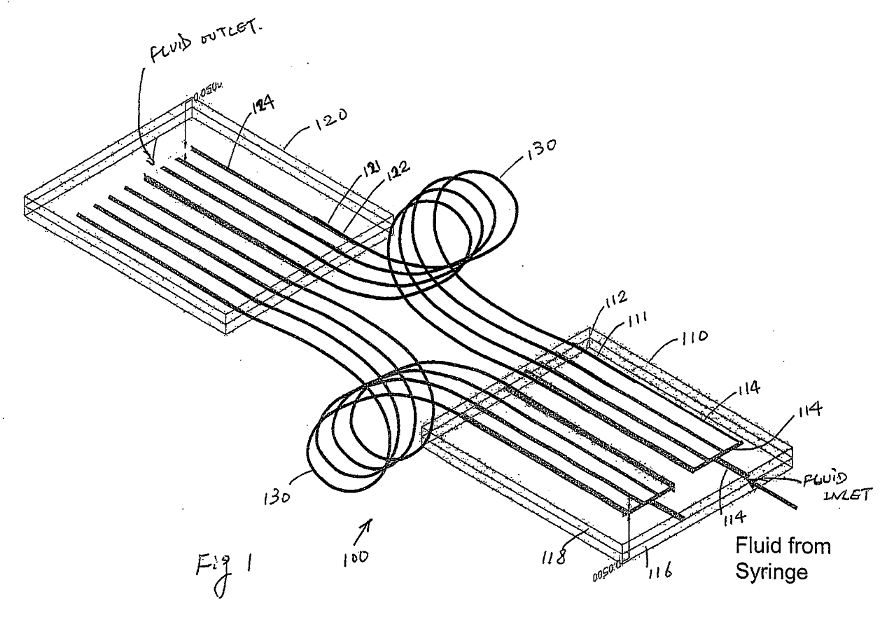

FIG. 1 is a simplified schematic illustration of a nanofluidic system 100 having two connector or interface apparatuses 110 and 120 connected by a set of flexible hollow fibers 130 according to exemplary embodiments of the invention. A nanofluidic connector or interface may be referred to herein as a hollow fiber connector, or simply as a connector, for the purpose of clarity. Apparatus 110 and apparatus 120 may include a set of connectors, for example, connectors 111 and 121. Connector 111 may hold one of hollow fibers 130 to allow the flow of fluid being injected into and/or taken out of the hollow fiber, as well as transported between apparatuses 110 and 120.

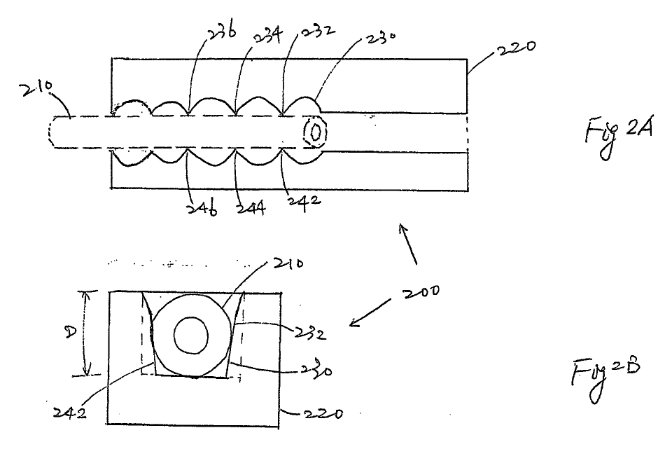

Connector 111 may include a connecting channel 112 machined or otherwise formed in a substrate 116. At least part of connecting channel 112 may have a set of protrusions, ridges or extensions formed along its sidewalls, as is described in detail in FIGS. 2A and 2B below. Apparatus 110 and apparatus 120 may also include one or more guiding channels, for example, guiding channels 114 and 124. Guiding channel 114 may not generally have any ridges or extensions but the invention is not limited in this respect. Guiding channel 114 may extend from a channel that has ridges or extensions, for example from a channel formed from a set of machined holes. Guiding channel 114 may be wider than a width at the ridges of a connecting channel. Guiding channel 114 may guide fluid to and from connecting channels or other channels.

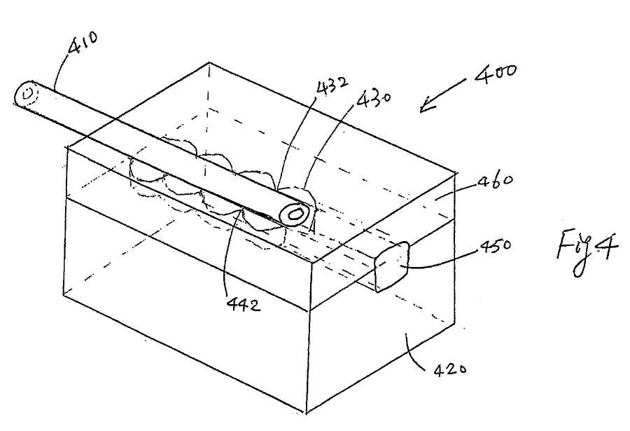

Guiding channel 114 may be machined or otherwise formed on the same substrate 116 as connecting channel 112, have a comparable cross-sectional area as connecting channel 112, and lead to, fluidly connect to, connecting channel 112. In situations where a hollow fiber is held by a connecting channel but enters the connecting channel via a an initial channel with no protrusions, ridges or extensions (e.g., the initial portion of the channel in FIG. 4), the initial portion of the channel may be machined or manufactured to have a larger diameter or cross sectional area than the largest diameter or cross sectional area of the connecting channel so that the initial portion of the channel may not block the hollow fiber from being inserted into the connecting channel. Both connecting channel 112 and guiding channel 114 may be covered by a substrate 118, in other words, be embedded between substrates 116 and 118. Substrates 116 and 118 may be made of semiconductor materials such as Silica glass but the invention is not limited in this respect. Other substrate materials may be used. Substrates 116 and 118 may be attached to each other or tightly glued together by a suitable material such as an index-matching fluid but the invention is not limited in this respect. Other materials may be used in between substrates 116 and 118. Guiding channel 114, as well as connecting channel 112, may open at the edge of substrate 116 but the invention is not limited in this respect. An opening and/or inlet may be made at the surface of either substrate 116 or substrate 118 for various fluid and fiber handling purposes. Guiding channel 124 and connecting channel 112 may also have openings and/or inlets and/or outlets at the edge or surfaces of apparatus 120.

Fluid injected into guiding channel 114, for example, by an input, an inlet, a tube, a fiber, a syringe or other source at the edge of apparatus 110, which is the edge of substrate 116, may be confined within guiding channel 114 and led to connecting channel 112. Connecting channel 112 may hold one of hollow fibers 130 that may receive the fluid from guiding channel 114 and transport the fluid to connecting channel 122 on apparatus 120. In a reverse direction, guiding channel 114 may accept fluid from connecting channel 112. Nanofluidic system 100 may interface, via connector or interface apparatus 110 and/or 120, with other nanofluidic systems, microfluidic systems, mesofluidic systems, macrofluidic system, or any combination thereof.

FIGS. 2A is a schematic illustration of a top view of a nanofluidic connector 200 adapted to hold a hollow fiber 210 according to exemplary embodiments of the invention. Connector 200 may include a connecting channel 230 machined, drilled or otherwise formed on a substrate 220. Connecting channel 230 may have, in all or part of its length, a set of protrusions, ridges or extensions, for example, protrusions, ridges or extensions 232, 234, 236 and ridges or extensions 242, 244, 246, evenly or unevenly formed along the two sidewalls of connecting channel 230. Ridges or extensions 232, 234, and 236 may be aligned with ridges or extensions 242, 244, and 246, respectively, on the opposite wall but the invention is not limited in this respect. For example ridge 232 and opposite ridge 242 may be offset by a certain length. The number of ridges or extensions along the sidewalls may be, for example, in the 10's or 100's depending on the length of connecting channel 230 and a desired holding power of connector 200; other numbers of ridges may be used. In one embodiment, a distance between two closest ridges, for example, ridges 232 and 234, on the same sidewall may be in the range of 50-100 micrometers, but may be less than, comparable to, or larger than the diameter of hollow fiber 210 to be held by connector 200 although the invention is not limited in this respect. For example, the distance between two closest ridges 232 and 234 may be over 100 micrometers. Other distance ranges may be used.

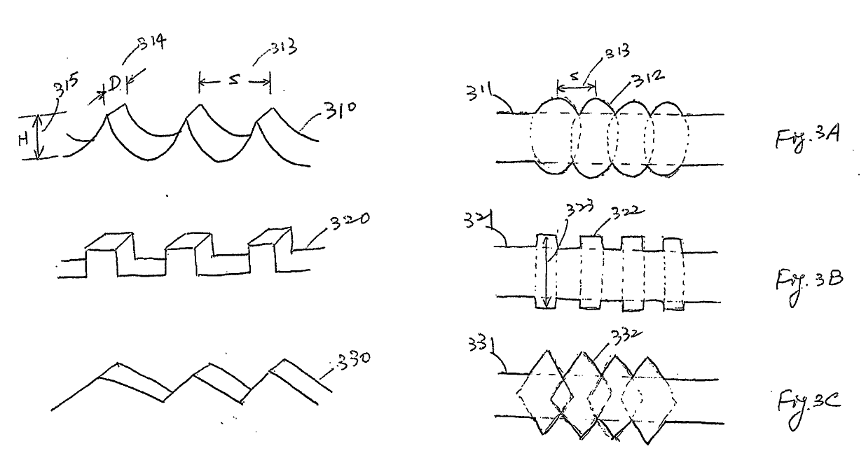

FIG. 2B is a schematic illustration of a cross-sectional view of nanofluidic connector 200 according to exemplary embodiments of the invention. FIG. 2B shows a connecting channel 230 at the position of protrusions, ridges or extensions 232 and 242, as is shown in FIG. 2A. The cross-sectional shape of connecting channel 230 may be substantially close to a square, although the invention is not limited in this respect and other suitable shapes may be used. For example, a trapezoidal channel shape, with the width at the top of the channel being slightly bigger than the width at the bottom, may be formed during, for example, a laser ablation system, drilling or otherwise forming a series of solid holes, as described below in FIG. 3, to form a set of ridges or extensions. The holes may be generally perpendicular to the substrate and have a desired depth. In other embodiments the drilling need not be perpendicular. The width of the channel at a position of ridges or extensions 232 and 242 may be made slightly narrower than the diameter of hollow fiber 210 so that connecting channel 230 may hold hollow fiber 210 firmly, but, according to one embodiment, may not be too narrow to affect the fluid flow therein. It will be appreciated by person skilled in the art that the width of connecting channel 230 at a position other than at the ridges or extensions, for example, in the middle point between ridges or extensions 232 and 234, may be wider than the diameter of hollow fiber 210. An un-ridged or relatively smooth portion of the channel may have a diameter or cross sectional area that is larger than the widest part at positions of the ridges or extensions.

Ridges may be formed at intersections of a series of geometric shapes or drilled or machined shapes, for example circles, squares, etc. In one embodiment the distance between two adjacent shapes (e.g., circles) is less than the diameter or longest dimension (e.g., diagonal) of the shapes. In the case where the geometric shape is an oval, the distance between two adjacent ovals may be less than a short diameter of the ovals. In the case where the shape is a rectangle, each rectangle may have a width larger than the width of the channel.

FIGS. 3A, 3B, and 3C are schematic illustrations of some shapes of ridges or extensions which may be formed on the sidewalls of connecting channel 230 to hold hollow fiber 210 (FIG. 2A) according to exemplary embodiments of the invention. It will be appreciated by person skilled in the art that the invention is not limited to the shapes of ridges or extensions illustrated in either FIG. 3A, FIG. 3B, or FIG. 3C, and may include other shapes of ridges or extensions. In one embodiment, a series of uniform shapes separated by a uniform distance may be used.

The geometry of protrusions, ridges or extensions 310 may be formed, for example, by a laser ablation system (not shown), drilling or otherwise forming a series of overlapped generally circular holes 312 along a pre-formed channel 311. According to one exemplary embodiment of the invention, channel 311 may be machined or otherwise formed after the series of holes 312 are formed. A distance 313 (S) between two adjacent holes 312 may be less than the diameter of holes 312. If shapes other than holes are used, the distance between the center of the shapes (e.g., generally square, oval diamond, etc.), may be less than the largest width of the shape. Holes 312 drilled to form the ridges or extensions may have a circular shape but the invention is not limited in this respect and the holes may have other shapes such as an oval shape. It will also be appreciated by person skilled in the art that the drilling process may be performed in other manners, for example, dry and/or wet etching, other than a laser ablation system.

According to exemplary embodiments of the invention, a height 315 (H) of the protrusions, ridges or extensions, as measured from the tip of the ridge to the bottom of the arc, may be determined by the ratio of the diameter of holes 312 relative to a circle-to-circle distance 313. A depth 314 (D) of the ridges or extensions, which may be the depth of connecting channel 230 (FIG. 2B), may be controlled during the drilling process, such as by adjusting the wavelength, the energy, and the number of light pulses delivered by the laser ablation system. Other methods of adjusting parameters may be used.

The geometry of the ridges or extensions may also be made to have other shapes, for example, a rectangular or trapezoidal shape as in 320 of FIG. 3B, or a triangle shape as in 330 of FIG. 3C. Other suitable shapes may be used. According to exemplary embodiments of the invention, protrusions, ridges or extensions may be formed on the sidewalls of a channel by similar processes as described above for ridges or extensions in FIG. 3A. For example, a connecting channel with a set of ridges or extensions of rectangular shape 320 may be formed by first drilling or machining a uniform channel 321 on a substrate, and then drilling or machining a series of rectangles 322 overlaying the uniform channel 321 wherein the rectangles having at least one dimension 323 larger than the width of uniform channel 321. Similarly, a set of ridges or extensions of triangular shape 330 may be formed by machining a series of cascaded, overlapped, diamonds 332 overlaying a uniform channel 331. It will be appreciated by person skilled in the art that uniform channels 321 and/or 331 may be formed following the formation of the series of rectangles 322 and/or diamonds 332. The widths of uniform channels, for example, channels 311, 321, and 331, may be made slightly wider than the width as measured at the position of ridges or extensions. In one embodiment of the invention, the series of rectangles 322 and/or diamonds 332 may be connecting channels and uniform channels 321 and/or 331 may not be formed.

FIG. 4 is a simplified perspective illustration of a nanofluidic connector 400 adapted to hold a hollow fiber 410 for fluid transportation according to exemplary embodiments of the invention. Hollow fiber 410 may be held by a connecting channel 430 having a set of ridges or extensions, for example, ridges 432 and 442, formed on the sidewalls of connecting channel 430. A smooth or un-ridged initial portion may allow a fiber to pass without gripping to a portion with ridges or extensions; the diameter of such an un-ridged portion may be somewhat larger than a portion with ridges. Connecting channel 430 may lead to a guiding channel 450. Guiding channel 450 may be machined to have a comparable cross-sectional area as connecting channel 430, and may generally not have ridges or extensions. However, the invention is not limited in this respect and guiding channel 450 may have a set of ridges or extensions. Connecting channel 430 and guiding channel 450 may be made or formed, on a first substrate 420 and covered by a second substrate 460. Both substrates 420 and 460 may have similar ridges or extensions, and the ridges or extensions in each substrate may match when substrates 420 and 460 are attached together. In an alternate embodiment, only one substrate may have ridges or extensions machined therein, and the other substrate may simply “cap” the first substrate, or may have a non-ridged channel matching the ridged channel. In one embodiment, when substrate 420 is covered by substrate 460, the cross-sectional area of machined channel may be close to cross-sectional area of hollow fiber 410. Connecting channel 430 and guiding channel 450 may open at the edges of substrate 420 and/or substrate 460.

Hollow fiber 410 may be inserted into, and held by, connecting channel 430. Small gaps between hollow fiber 410 and connecting channel 430 may exist due to, for example, possible mismatch in cross-section between a square-like shape of connecting channel 430 and a circular shape of hollow fiber 410. The gaps may be filled up by some filler materials (not shown), for example, an index-matching fluid and/or silicon gels, but the invention is not limited in this respect and the materials used may be dependent on the materials of substrates 420 and 460. Fluid for transportation may be injected into and/or taken out of hollow fiber 410 via connecting channel 430 at guiding channel 450 with little or no leakage.

It was demonstrated in experiment that nanofluidic connectors manufactured in accordance with some exemplary embodiments of the invention had a pull-out force that exceeded the mechanical strength of hollow fibers used (e.g., 100-250 MPa UTS, 80 MPa Y.S.), and delivered fluid at, at least, 3 ATM of pressure without causing visible deformation to the hollow fibers. Other pull-out forces or mechanical strengths may be achieved by connectors made in accordance with other embodiments of the invention.

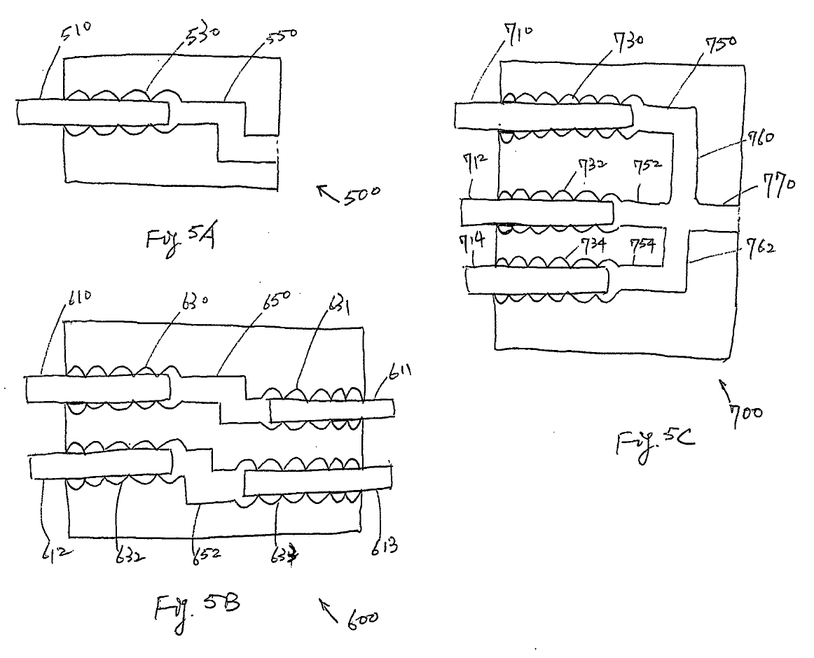

FIGS. 5A, 5B, and 5C are schematic illustrations of sample nanofluidic connector apparatuses adapted to hold and/or connect one or more hollow fibers according to exemplary embodiments of the invention. It will be appreciated by person skilled in the art that the illustrated apparatuses are merely examples of applications of the nanofluidic connector of this invention. The scope of the invention is not limited in this respect.

FIG. 5A illustrates a connector apparatus 500 having a connecting channel 530 leading to or extending from a guiding channel 550 according to one embodiment of the invention. A hollow fiber 510 may be held by connecting channel 530. Guiding channel 550 may be machined to have a variety of longitudinal shapes, such as to have one or more turns, to serve a variety of fluid handling purposes. In addition, guiding channel 550 may be made to have an opening and/or inlet on the surface of a top or bottom substrate (not shown) for fluid injection and/or extraction, and may opens at the edge of substrate as shown in FIG. 5A.

FIG. 5B illustrates a connector apparatus 600 having two or more pairs of connecting channels, for example, connecting channels 630-633, connected by two or more respective guiding channels, for example, guiding channels 650 and 651, according to another embodiment of the invention. Connecting channels 630-633 may hold two or more hollow fibers 610-613. Connecting channels 630-633 and guiding channels 650 and 651 may be machined on a common substrate.

FIG. 5C illustrates a connector apparatus 700 having a set of connecting channels connected via one or more guiding channels to a common guiding channel according to another embodiment of the invention. For example, connecting channels 730-734 may be connected via guiding channels 750-754, 760, and 762 to a common guiding channel 770. A set of hollow fibers, for example, hollow fibers 710-714, may be held by connecting channels 730-734, respectively. Fluid injected into guiding channel 770 may be distributed to guiding channel 760 which leads to guiding channel 750; to guiding channel 752; and to guiding channel 762 which leads to guiding channel 754. The fluid may then be respectively received, accepted, by hollow fibers 710-714. On a reverse direction, fluid transported by hollow fibers 710-714 to connecting channels 730-734 may be collected by guiding channel 770.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

What is claimed is:

1. An apparatus to hold one or more hollow fibers for transporting fluid, the apparatus comprising:
at least one connecting channel formed in a substrate, wherein said connecting channel includes at least a plurality of ridges to hold at least one of said hollow fibers.

2. The apparatus of claim 1, comprising at least a guiding channel leading to the connecting channel to guide fluid to and from the connecting channel.

3. The apparatus of claim 1, wherein said connecting channel opens at an edge of said substrate.

4. The apparatus of claim 1, wherein said apparatus comprises a second substrate attached to the substrate to cover said connecting channel.

5. The apparatus of claim 1, wherein said connecting channel is a first connecting channel and said apparatus comprises a second connecting channel and a guiding channel which fluidly connects the first and second connecting channels.

6. The apparatus of claim 1, comprising first and second sets of connecting channels, wherein each of said connecting channels from the first set is fluidly connected to a corresponding said connecting channel from the second set.

7. The apparatus of claim 1, comprising a plurality of connecting channels, wherein each of said plurality of connecting channels leads to a common guiding channel.

8. The apparatus of claim 1, wherein said ridges are formed at intersections of a series of geometric shapes.

9. The apparatus of claim 8, wherein said geometric shape is a circle, and wherein a distance between two adjacent said circles is less than the diameter of said circles.

10. The apparatus of claim 8, wherein said geometric shape is an oval, and wherein a distance between two adjacent said ovals is less than a short diameter of said ovals.

11. The apparatus of claim 1, wherein said ridges have a rectangular shape formed by a series of separated rectangles overlaid on top of a uniform channel, and wherein each rectangle has a width larger than the width of said uniform channel.

12. The apparatus of claim I, wherein said ridges have a triangular shape formed by a series of cascaded diamonds.

13. A device comprising:
a substrate including a connecting channel, the connecting channel including
at least a plurality of extensions, the extensions to hold a hollow fiber.

14. The device of claim 13, wherein said channel holds said hollow fiber to provide a pullout force for the hollow fiber that exceeds the mechanical strength of the hollow fiber.

15. A method for making a nanofluidic connector, the method comprising:
drilling a plurality of holes on a substrate along a line, wherein said holes are generally perpendicular to said substrate and have a desired depth.

16. The method of claim 15, wherein said holes overlap with each other to form a connecting channel and a plurality of ridges are formed at the intersections of said holes.

17. The method of claim 15, wherein the drilling is by laser ablation.

18. The method of claim 15, wherein the holes are generally circular.

19. The method of claim 15, wherein the holes are generally oval.

20. The method of claim 15, wherein the holes have a diamond shape.

21. The method of claim 15, wherein the holes are generally rectangular.

22. The method of claim 15, comprising:
machining a channel on said substrate over said plurality of holes to form a connecting channel.

23. The method of claim 16, comprising:
machining a channel on said substrate extending from said plurality of holes to form a guiding channel.

24. The method of claim 23, wherein said guiding channel is wider than a width at the ridges of said connecting channel.

25. The method of claim 22, wherein the channel opens at an edge of said substrate.
